(19) United States
(12) Patent Application Publication
(10) Pub. No.: US 2024/0413651 A1
(43) Pub. Date: Dec. 12, 2024

(54) MULTIFUNCTIONAL EARPHONE CHARGING CASE AND CONTROL METHOD THEREFOR, AND TERMINAL CONTROL SYSTEM

(71) Applicant: Goertek Inc., Weifang, Shandong (CN)

(72) Inventors: Bo Liang, Shandong (CN); Haijun Yin, Shandong (CN)

(73) Assignee: Goertek Inc., Weifang, Shandong (CN)

(21) Appl. No.: 18/702,457

(22) PCT Filed: Oct. 9, 2022
(86) PCT No.: PCT/CN2022/124121

§ 371 Date: Apr. 18, 2024

(30) Foreign Application Priority Data
Oct. 28, 2021 (CN) 202111267425.5

(51) Int. Cl. H02J 7/00; G06F 3/0338; G06F 3/0354; G06F 3/038; H04R 1/10

(52) U.S. Cl. CPC H02J 7/0044; G06F 3/0338; G06F 3/03543; G06F 3/038; H04R 1/1025; G06F 2203/0384

(57) ABSTRACT

The present disclosure provides a multifunctional earphone charging case configured with a charging case mode, a joystick mode and a mouse mode, and comprises: a case body; a charging module provided in the case body; a sensor module provided on the case body; a user inputting module provided on the case body; a main controller electrically connected to the charging module, the sensor module and the user inputting module respectively, the main controller is configured for controlling the charging module, the sensor module, and the user inputting module to work according to a mode selection signal triggered by a user, such that the multifunctional earphone charging case works in at least of the following modes: the charging case mode, the joystick mode, and/or the mouse mode.

### CROSS-REFERENCE TO RELATED APPLICATIONS

The present disclosure is a National Stage of International Application No. PCT/CN2022/124121, which claims priority to a Chinese patent application No. 202111267425.5 filed with the CNIPA on Oct. 28, 2021 and entitled “MULTIFUNCTIONAL EARPHONE CHARGING CASE AND CONTROL METHOD THEREFOR, AND TERMINAL CONTROL SYSTEM”, both of which are hereby incorporated by reference in their entireties.

### TECHNICAL FIELD

The present disclosure relates to the field of a charging case, and particularly to a multifunctional earphone charging case and a control method therefor, and a terminal control system.

### BACKGROUND

AR/VR products usually need a matching joystick or ring to complete the operation of the app in the UI interface during use, which requires the development of independent accessories, resulting in a waste of resources. Daily mobile terminals, such as pads and PCs, also need a matching mouse to work in daily office, and also need a Bluetooth headset to receive audio. In the comprehensive application scenario, it is necessary to match the three accessories of joystick/ring, mouse and Bluetooth headset at the same time to realize the above functions, which makes the control of the terminal device complicated and is not conducive to the operation of users, and at the same time, is liable to a serious waste of resources and rising costs.

### SUMMARY

A main objective of the present disclosure is to provide a multifunctional earphone charging case and a control method therefor, and a terminal control system intended for improving convenience of an operation on a terminal device by a user and reducing waste of resources.

For achieving the above objective, the present disclosure provides a multifunctional earphone charging case, which is configured with a charging case mode, a joystick mode and a mouse mode, and comprises:

a case body:

a charging module provided in the case body:

a sensor module provided on the case body:

a user inputting module provided on the case body; and

a main controller electrically connected to the charging module, the sensor module and the user inputting module respectively, the main controller being configured for controlling the charging module, the sensor module and the user inputting module to work according to a mode selection signal triggered by a user, such that the multifunctional earphone charging case works in any one or any combination of the charging case mode, the joystick mode, and/or the mouse mode.

Optionally, the mode selection circuit comprises:

a function selection button provided on the case body, connected to the main controller, and outputting corresponding mode selection signal when triggered by the user.

Optionally, the multifunctional earphone charging case further comprises a wireless communication module configured for realizing a wireless communication connection between the main controller and the terminal device:

the mode selection circuit further comprises:

a pairing button provided on the case body, connected to the main controller, and outputting a pairing button signal when triggered by the user:

the main controller is further configured for controlling the wireless communication module and the terminal device to establish the wireless communication connection when receiving the pairing button signal.

Optionally, the user inputting module comprises:

a touch panel provided on a housing and connected to the main controller:

the main controller is further configured for when the multifunctional earphone charging case works in the joystick mode, controlling the touch panel to work, receiving a touch information generated when the touch panel is triggered by the user, and generating a corresponding control signal according to the touch information.

Optionally, the sensor module further comprises:

a display module provided on the case body and connected to the main controller:

the main controller is further configured for when the multifunctional earphone charging case works in the joystick mode, controlling the display module to work, and outputting a display control signal to the display module for displaying image information.

Optionally, the sensor module comprises:

a plurality of ultrasonic sensors respectively provided on adjacent sidewalls at an end of the case body, and connected to the main controller respectively:

a motion sensor provided in the case body and connected to the main controller:

the main controller is further configured for when the multifunctional earphone charging case works in the joystick mode, controlling the plurality of ultrasonic sensors to work such that the plurality of ultrasonic sensors transmit ultrasonic signals to the terminal device; and/or, controlling the motion sensor to work so as to acquire a rotation direction and acceleration information of the multifunctional earphone charging case.

Optionally, the user inputting module further comprises:

a button detection circuit comprising pressure detecting components and a signal processor whose output end is connected to the main controller, the pressure detecting components being provided on an inner wall of the case body and respectively connected to a signal detecting end of the signal processor:

the main controller is further configured for when the multifunctional earphone charging case works in the mouse mode, controlling the button detection circuit to work, and receiving pressure values acquired by two pressure detecting components so as to determine an area where the multifunctional earphone charging case is clicked.

Optionally, the sensor module further comprises:

a displacement detection sensor provided on the case body and connected to the main controller:

the main controller is further configured for when the multifunctional earphone charging case works in the mouse mode, controlling the displacement detection sensor to work, and receiving a displacement detection value acquired by the displacement detection sensor so as to determine a current position of the multifunctional earphone charging case.

The present disclosure further provides a terminal control system, which comprises a terminal device and the above multifunctional earphone charging case:

the terminal device is in wireless communication connection with the multifunctional earphone charging case.

The present disclosure further provides a control method for a multifunctional earphone charging case, the multifunctional earphone charging case is provided with a charging module, a sensor module and a user inputting module, and the control method for a multifunctional earphone charging case comprises following steps:

acquiring a mode selection signal triggered by a user:

controlling the charging module, the sensor module and the user inputting module to work according to the mode selection signal, such that the multifunctional earphone charging case works in any one or any combination of the charging case mode, the joystick mode, and/or the mouse mode.

Optionally, step of said “controlling the charging module, the sensor module and the user inputting module to work according to the mode selection signal, such that the multifunctional earphone charging case works in any one or any combination of the charging case mode, the joystick mode, and/or the mouse mode” specifically comprises:

when the multifunctional earphone charging case only works in the charging case mode, controlling the sensor module and the user inputting module to stop working:

when the multifunctional earphone charging case works in the mouse mode or the joystick mode, controlling the charging module, the sensor module and the user inputting module to work, or controlling the charging module to stop working.

Optionally, step of said “controlling the charging module, the sensor module and the user inputting module to work according to the mode selection signal, such that the multifunctional earphone charging case works in any one or any combination of the charging case mode, the joystick mode, and/or the mouse mode” specifically comprises:

when the multifunctional earphone charging case works in the mouse mode or the joystick mode, acquiring electric quantity information of the multifunctional earphone charging case, as well as earphone on-site information and earphone electric quantity information in the multifunctional earphone charging case:

controlling the charging module to work/stop working according to the electric quantity information of the multifunctional earphone charging case, as well as the earphone on-site information and the earphone electric quantity information in the multifunctional earphone charging case.

By providing the charging module, the sensor module and the user inputting module, and by controlling the working state of the charging module, the sensor module and the user inputting module via the main controller electrically connected to the charging module, the sensor module and the user inputting module respectively according to the mode selection signal triggered by the user such that the multifunctional earphone charging case works in any one or any combination of the charging case mode, the joystick mode, and/or the mouse mode, the present disclosure provide a new charging case, which integrates the functions of the TWS earphone charging case, the AR/VR joystick and the mouse into the multi-functional earphone case in terms of overall function, thus realizes functions of the mouse, the AR matching joystick, and the earphone charging storage box on the same charging case, realizes the integration and expansion of the functions of the charging case, contributes to simplifying the kinds of peripherals and may improve the convenience of being carried by the user. The charging case of the present disclosure is suitable for the needs of the user in different application scenarios, improves the convenience of the operation on the terminal device by the user, and reduces the waste of resources.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a schematic illustration of functional modules of a multifunctional earphone charging case according to an embodiment of the present disclosure;

FIG. 2 is a schematic illustration of a circuit of an embodiment of the multifunctional earphone charging case of FIG. 1:

FIG. 3 is a schematic illustration of a circuit of another embodiment of the multifunctional earphone charging case of FIG. 1:

FIG. 4 is a schematic illustration of a circuit of yet another embodiment of the multifunctional earphone charging case of FIG. 1:

FIG. 5 is a schematic structural illustration of a multifunctional earphone charging case according to an embodiment of the present disclosure:

FIG. 6 is a schematic structural illustration of a multifunctional earphone charging case according to another embodiment of the present disclosure:

FIG. 7 shows a schematic structural illustration of an ultrasonic sensor of the present disclosure on the charging box in one view:

FIG. 8 shows a schematic structural illustration of an ultrasonic sensor of the present disclosure on the charging box in another view:

FIG. 9 shows a schematic structural illustration of an ultrasonic sensor of the present disclosure on the charging box in yet another view:

FIG. 10 shows a schematic structural illustration of a multifunctional earphone charging case according to yet another embodiment of the present disclosure:

FIG. 11 shows a flowchart of a control method for a multifunctional earphone charging case according to an embodiment of the present disclosure:

FIG. 12 shows a schematic illustration of a refined process for an embodiment of step S200 of FIG. 10;

FIG. 13 shows a schematic illustration of a refined process for another embodiment of step S200 of FIG. 10.

### DESCRIPTION OF REFERENCE SIGNS

| Num. | Name | Num. | Name |
|---|---|---|---|
| 10 | case body | 42 | button detection |
| | | | circuit |
| 11 | top cover | S1 | function selection |
| | | | button |
| 12 | bottom housing | S2 | pairing button |
| 20 | charging module | U1 | ultrasonic sensor |
| 21 | charging chip | U2 | motion sensor |
| 22 | OVP CHIP | U3 | displacement |
| | | | detection sensor |
| 23 | earphone in-box | 421 | pressure detecting |
| | detection sensor | | component |
| 24 | battery | 422 | signal processor |
| 30 | sensor module | 421a | piezoresistive |
| | | | sensor |
| 40 | user inputting module | 421b | piezoelectric sensor |
| 50 | main controller | U31 | laser driver |
| 60 | display module | U32 | laser |
| 41 | touch panel | U33 | photoelectric sensor |

The realization of the objects, functional features and advantages of the present disclosure will be further described in connection with the embodiments, with reference to the accompanying drawings.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, and not all of them. Based on the embodiments in the present disclosure, all other embodiments obtained by a person of ordinary skill in the art without making creative labor fall within the scope of protection of the present disclosure.

It should be noted that if embodiments of the present disclosure involve directional indications (such as up, down, left, right, forward, back . . . ), the directional indications are used only for explaining the relative positional relationships, movements, and the like among the various components in a particular attitude (as shown in the accompanying drawings), and are correspondingly changed if the particular attitude is changed.

In addition, embodiments of the present disclosure involve description of terms “first”, “second” and the like, and they are only used for descriptive purposes and should not be understood as indicating or implying relative importance or implying a number of indicated technical features. Therefore, a feature delimited with “first”, “second” may expressly or implicitly include at least one of those features. In addition, the technical solutions of the embodiments may be combined with each other, but must be based on the fact that a person of ordinary skill in the art can realize. When the combination of the technical solutions is contradictory or cannot be realized, it should be considered that the combination of the technical solutions does not exist and is not within the protection scope of the present invention.

The term “and/or” herein is merely an association relationship describing an associated object, indicating that there may be three relationships, for example, A and/or B, which may mean that A exists alone, A and B exist simultaneously, and B exists alone. In addition, the character “/” in this document generally indicates that the object associated before and after is a kind of “or” relationship.

The present disclosure provides a multifunctional earphone charging case.

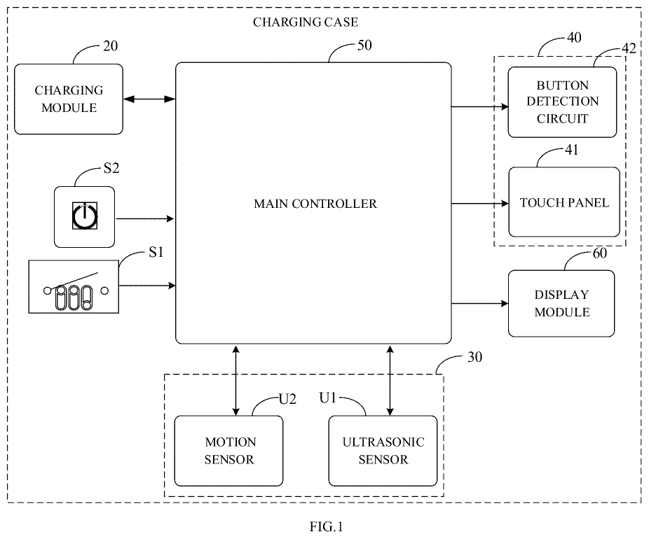

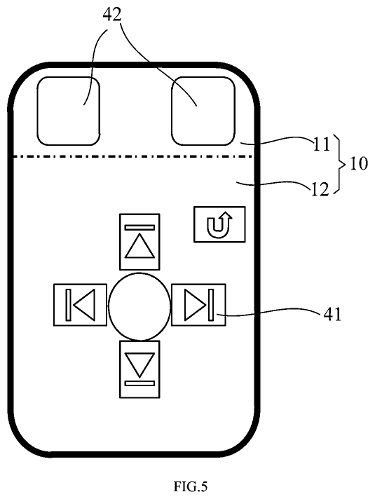

Referring to FIGS. 1 to 9, the multifunctional earphone charging case is configured with a charging case mode, a joystick mode and a mouse mode, and comprises:

a case body 10:

a charging module 20 provided in the case body 10:

a sensor module 30 provided on the case body 10:

a user inputting module 40 provided on the case body 10; and

a main controller 50 electrically connected to the charging module 20, the sensor module 30 and the user inputting module 40 respectively: the main controller 50 is configured for, according to the mode selection signal triggered by the user, controlling the working state of the charging module 20, the sensor module 30, and the user inputting module 40, such that the multifunctional earphone charging case works in any one or any combination of the charging case mode, the joystick mode, and/or the mouse mode.

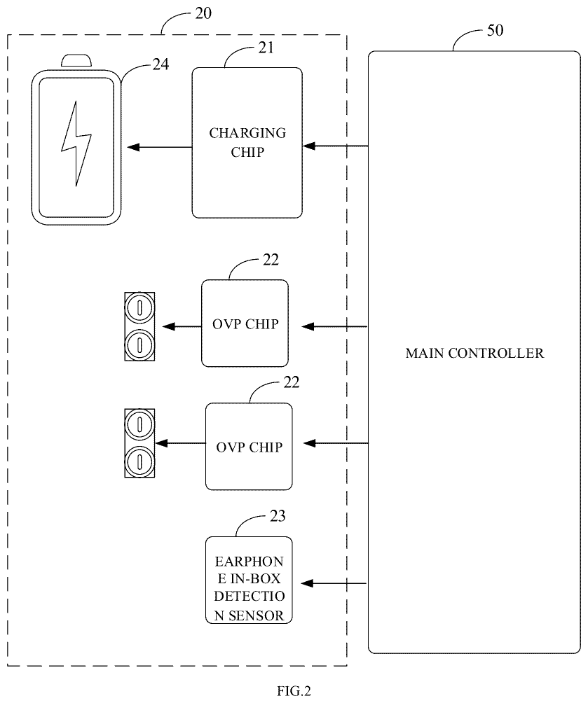

With reference to FIG. 2, in the present embodiment, the charging case may be applied to charging wireless earphones, especially Bluetooth earphones, such as TWS (True Wireless Stereo) earphones. Most of the wireless earphones have a power supply inside, such as accumulator 24, but its own power supply is generally limited in capacity, so charging case is needed to charge the wireless earphones. When the wireless earphone is not used, it may also be stored in the charging case to avoid loss. The charging case may communicate with the earphone, thereby realizing functions such as forced pairing, switching box action, and OTA upgrade of the TWS earphone, etc. The charging case is further provided with a circuit board and a charging case energy storage module, which is provided on the circuit board and mounted in the case body 10. The charging case energy storage module includes an accumulator 24, and the shape and size of the holding chamber in the case body 10 may be adapted to the accumulator 24, the circuit board, and the earphone placed in the case body 10, and may be in the shape of a circle, a square, and the like, which is not limited herein. The case body 10 may optionally be made of a lightweight, insulating material. The accumulator 24 is used to supply power to a wearable device such as a wireless earphone, the charging case has a top cover 11 and a bottom housing 12, the top cover 11 is covered by the bottom housing 12, the bottom housing 12 may be provided with a charging switch or a touch switch, such as a touch screen, and the charging switch is electrically connected to the circuit board to control the accumulator 24 to charge the wireless earphone, or to stop charging, upon receiving a charging switch signal input by a user. A recess may be provided in the charging case for insertion of the wireless earphone. Since the wireless earphone is generally used for human ears, it may comprise a pair of earphones symmetrical with respect to the housing, and the charging case may correspondingly have two charging ports. The charging case may also be used to house the earphone when the wireless earphone is in a non-charging state.

The charging case is further provided with a discharge port in the case body 10 and a charging port on the case body 10, wherein the discharge port is electrically connected to the accumulator 24, and the charging port is electrically connected to the accumulator 24. Specifically, the discharge port is electrically connected to the accumulator 24 and the charging port is electrically connected to the accumulator 24. Wherein, the main controller 50 is used to implement charging, mouse control, joystick control, and other functions of the charging case, and may also be a System on Chip (SOC). The SOC chip may be integrated with a processor, a Bluetooth radio frequency and an antenna part, and the main control chip thereof realizes the management of the charging logic, the switching of each function mode, the data processing of the sensor module 30, processing of the touch control algorithm, the displacement detection algorithm and the like. In some optional embodiments, the main controller 50 may also be a Central Processing Unit (CPU), but also be other general-purpose main controller 50, Digital Signal Processor 50 (DSP), Application Specific Integrated Circuit (ASIC), Field-Programmable Gate Array (FPGA), or a combination of one or more of other programmable logic devices, discrete gate or transistor logic devices, discrete hardware components, and the like. The general-purpose main controller 50 may be a conventional main controller 50 such as a single chip microcomputer. The memory may be an internal storage unit of the device, such as a hard disk or an internal storage of the device. The charging case may also include a memory for storing computer programs, algorithms, and other programs and data required by the charging case.

The charging module 20 comprises a charging chip 21 and an OVP (over-voltage and over-current) chip 22, wherein the charging chip 21 is electrically connected to the main controller 50, and manages the charging of the large-capacity battery in the charging case and charges the earphone placed in the case body 10 based on the control of the main controller 50; the OVP CHIP 22 is used to prevent an OVP abnormality from occurring during charging of the wireless earphone by the charging case. The charging case may also be provided with an earphone in-box detection sensor 23, such as Hall sensor, infrared sensor, contact sensor, etc., and when the earphone is detected to be connected, the charging module 20 converts the power stored in accumulator 24 into the charging power for the wireless earphone, thereby charging the wireless earphone. Of course, in other embodiments, when the main controller 50 establish a communication connection with the wireless earphone, and it is determined that the wireless earphone needs to be charged, then controlling the charging module 20 to charge the wireless earphone: the charging case may also be provided with a voltameter for acquiring the remaining capacity of the battery of the charging case, and the voltameter may detect the lithium battery of the charging case in real time.

The sensor module 30 is integrated with a sensor for realizing a joystick function, such as a motion sensor, a gyroscope, and the like, and a sensor for realizing a mouse function, such as a laser sensor, a photoelectric sensor, and the like. The sensor module 30 may also include a light sensor, a motion sensor, and other sensors. Specifically, the light sensor includes an ambient light sensor and a proximity sensor, wherein the ambient light sensor may perform the in-box detection according to the brightness of the ambient light. As a kind of motion sensor, the accelerometer sensor may also detect the magnitude of acceleration in all directions (generally three axes), may detect the magnitude and direction of gravity when stationary, and may also be used for recognizing the application of postures of the charging case (such as horizontal and vertical screen switching, related games, magnetometer posture calibration), and vibration recognition related functions (such as pedometer, tapping) and so on. The user inputting module 40 includes various devices for inputting button signals, and may include, for example, a touch panel 41, a touch button, and the like. The touch panel 41 may be used to implement a joystick function, and the touch buttons may be used to implement a mouse function. The user inputting module 40 may be used to receive input numeric or character information and to generate button signal inputs related to the control of the mouse function and the joystick function.

In the present embodiment, the charging case is integrated with at least two sets of control systems, which are provided with hardware architectures and software programs capable of realizing the two working modes of the joystick mode and the mouse mode, that is, a mouse operating system and a joystick operating system. The charging case may switch the mouse operating system and the joystick operating system according to the needs of the actual application, so that the charging case may work in the mouse working mode and the joystick working mode in addition to the normal charging case mode. When working in the joystick mode, the charging case may be held by the user with one hand or both hands. The charging case may define a common mode and an uncommon mode according to usage habits of the user. For example, when the frequency and number of times the user uses the charging case to charge the wireless earphone is higher than the frequency and number of times the user is using VR experiences, AR experiences, playing games, and operating the mouse, the charging case mode may be defined as the common mode, and the mouse mode and the joystick mode may be defined as the uncommon mode. When it is defined as the common mode, the charging case will be the charging case mode by default when it is turned on, and when the mouse mode or the joystick mode needs to be selected, the main controller 50 switches the charging case to the mouse mode or the joystick mode according to the mode selection signal triggered by the user. The charging case may work in only one mode or work in two modes at the same time, and even the three modes of the charging case mode, the joystick mode and the mouse mode may be compatible at the same time. When working in two modes at the same time, the two modes may be charging case mode and the joystick mode, or the charging case mode and the mouse mode, or the joystick mode and the mouse mode, which may specifically be selected and controlled according to the user's needs, whether the charging case supports the power, whether the wireless earphone is placed in the charging case, and whether the wireless earphone needs to be charged when it is placed in the charging case, which is not limited herein.

Wherein, the mode selection signal triggered by the user may be a button control signal (e.g., a button provided on the charging case, a number of times the button is pressed, a length of time the button is pressed, etc.), an action signal triggered by the user (e.g., shaking, flinging the charging case, etc.), or a gesture signal generated by controlling an attitude of the charging case (e.g., horizontal, vertical, front face up, back face up, etc.), etc., and the present embodiment may select a button control signal generated by trigger the button.

Referring to FIG. 1, in response to the mode selection signal triggered by the user, the main controller 50 may control the working state of the charging module 20, the sensor module 30 and the user inputting module 40. Specifically, when the user triggers a mode selection signal that characterizes only the charging case to charge the wireless earphone, the main controller 50 controls the charging module 20 to supply power to the wireless earphone to charge the wireless earphone, and at this time, the sensor module 30 and the user inputting module 40 are in a non-working state (for example, the functions of the touch panel 41, the left and right button functions of the mouse, the laser displacement sensor, and the like are all turned off). When the user triggers a mode selection signal characterizing that the charging case works only in the mouse mode, the main controller 50 controls the charging module 20 to stop supplying power so as to stop charging the wireless earphone, and at this time, in the sensor module 30 and the user inputting module 40, sensors, buttons and the like for realizing the mouse function are in the working state (the left and right button function of the mouse and the laser displacement sensor are turned on), and other sensors and the touch panel 41 unrelated to the mouse function (the function of the touch panel 41 is turned off) may be in the non-working state. Similarly, when the user triggers a mode selection signal characterizing that the charging case only works in the joystick mode, the main controller 50 controls the charging module 20 to stop supplying power so as to stop charging the wireless earphone, and at this time, in the sensor module 30 and the user inputting module 40, sensors, buttons and the like for realizing the joystick function are in the working state (the function of the touch panel 41 is turned on), and other sensors unrelated to the joystick function (the left and right button function of the mouse and the laser displacement sensor are turned off) may be in the non-working state. When the user triggers a mode characterizing that the two modes are compatible at the same time, in the charging module 20, the sensor module 30, and the user inputting module 40, the corresponding modules are in the working state, and other functions unrelated to the two modes may stop working, thereby reducing the power consumption generated by the sensor module 30 and the user inputting module 40 during standby. When controlling the working states of the modules such as the charging module 20, the sensor module 30, and the user inputting module 40, the control may be realized by controlling the on/off between the modules and the power supply, or in the module with the enabling function, the working state of the module may be changed by enabling the module, which may specifically be realized according to the adopted device and the like, and is not limited herein.

By providing the charging module 20, the sensor module 30 and the user inputting module 40, and by controlling the working state of the charging module 20, the sensor module 30 and the user inputting module 40 via the main controller 50 electrically connected to the charging module 20, the sensor module 30 and the user inputting module 40 respectively according to the mode selection signal triggered by the user such that the multifunctional earphone charging case works in any one or any combination of the charging case mode, the joystick mode, and/or the mouse mode. The present disclosure provide a new charging case, which integrates the functions of the TWS earphone charging case, the AR/VR joystick and the mouse into the multi-functional earphone case in terms of overall function, thus realizes functions of the mouse, the AR matching joystick, and the earphone charging storage box on the same charging case, realizes the integration and expansion of the functions of the charging case, contributes to simplifying the kinds of peripherals and may improve the convenience of being carried by the user. The charging case of the present disclosure is suitable for the needs of the user in different application scenarios, and improves the convenience of the operation on the terminal device by the user.

Referring to FIG. 1, in an embodiment, the mode selection circuit comprises:

a function selection button S1 provided on the case body 10, connected to the main controller 50, and outputting corresponding mode selection signal when triggered by the user.

In the present embodiment, the function selection button S1 may be realized by using a slide button, and the slide button has three gears, specifically divided into three gears A\B\C. The gear A is used to enter into the mouse mode, the gear B is the default charging case mode, and the gear C is used to enter into the joystick mode. The function selection button S1 is normally in the gear B, and when it is necessary to enter into the joystick mode or the mouse mode, the button may be slid to the gear A or C. The function selection button S1 may also be realized by using a function button, such as a pairing button S2, and the user may perform switch among the three modes according to the time length and the number of times of pressing the pairing button S2, and the like. In some embodiments, the slide button and the pairing button S2 may be combined to realize the simultaneous operation of two modes or three modes. Thus, the default state of the charging case is the normal earphone charging case mode, and when the function selection button S1 is moved to the position A, the charging case partially opens the function module of the mouse, for example, a displacement detection sensor U3 and a button detection circuit 42 in the sensor module 30; when the function selection button S1 is moved to the position C, the charging case turns on the six-axis sensor and the ultrasonic sensor U1 in the touch display module 60 and the sensor module 30, so as to realize the game controller and the touch function: when moving to the position B, the mouse-related module and the gamepad-related module are turned off and the system enters into a normal earphone charging case state.

Referring to FIG. 1, in an embodiment, the multifunctional earphone charging case further comprises a wireless communication module configured for realizing a wireless communication connection between the main controller 50 and the terminal device:

the multifunctional earphone charging case further comprises:

a pairing button S2 provided on the case body 10, connected to the main controller 50, and outputting a pairing button signal when triggered by the user:

the main controller 50 is further configured for controlling the wireless communication module and the terminal device to establish the wireless communication connection when receiving the pairing button signal.

It can be understood that the wireless earphone may need to be paired with other terminal devices through the charging case when the charging case works in the charging case mode, such as mobile phones, computers, smart watches, etc., so as to achieve Bluetooth connection: need to be in a Bluetooth connection with a computer, TV, or other device when the charging case works in the mouse mode: need to be connected to the game console, TV, VR device, AR device or other devices through Bluetooth when the charging case works in the joystick mode. For this purpose, the present embodiment also provides a wireless communication module including a Bluetooth module in the charging case, and provides a pairing button S2 on the charging case, and when the user triggers the pairing button S2, the wireless communication connection between the main controller 50 and the corresponding terminal device may be realized.

Wherein, when the charging case enters into a corresponding mode, the user may realize the pairing of the charging case and the corresponding terminal device by triggering the pairing button S2. For example, after entering into the mouse mode, the charging case may realize the wireless communication connection with a computer, and after entering into the joystick mode, the charging case may realize the wireless communication connection with the VR device and the AR device. It can be understood that the Bluetooth pairing and the wireless connection are operations and selections required by both the terminal device and the charging case. In order to reduce the operation of the user on the charging case, the charging case may also be triggered by pairing to enter into the corresponding mode. For example, when the charging case is paired with the VR device and the AR device, the user's demand is characterized as the joystick mode, and then the charging case may be directly controlled into the joystick mode. When the charging case is paired with the computer, the user's demand is characterized as the mouse mode, and then the charging case may be directly controlled into the mouse mode. Compared to the prior wireless mouse which needs to insert a transceiver into the computer, the present disclosure, by directly realizing the wireless connection with the computer and the like through the pairing button S2, may reduce the occupation of the transceiver of the wireless mouse on the USB interface of the computer.

Referring to FIG. 1, in an embodiment, the user inputting module 40 comprises:

a touch panel 41 provided on a housing and connected to the main controller 50:

the main controller 50 is further configured for when the multifunctional earphone charging case works in the joystick mode, controlling the touch panel 41 to work, receiving a touch information generated when the touch panel 41 is triggered by the user, and generating a corresponding control signal according to the touch information.

In the present embodiment, the user inputting module 40 may include a touch panel 41 and physical buttons. Wherein, the touch panel 41 may be used to implement the joystick function, and the touch panel 41 may collect the user's touch operations on or near the touch panel 41 (such as the user's operations on or near the touch panel 41 by using any suitable object or accessory such as a finger, a stylus, etc.), and drives the corresponding connecting device according to a preset program. The touch panel 41 may include a touch detection device and a touch controller. Wherein, the touch detection device detects a touch orientation of a user, detects a signal brought by a touch operation, and transmits the signal to the touch controller: the touch controller receives touch information from the touch detection device, converts the information into touch point coordinates, then sends them to the main controller 50, and can receive and execute commands sent from the main controller 50, such as whether to work, etc. The touch panel 41 may turn on or off the touch function according to the control signal output by the main controller 50. Specifically, when the main controller 50 triggers the charging case to work in the joystick working mode according to the mode selection signal, the touch panel 41 works, and the user may input the touch signal by operating the touch panel 41, for example, to operate the game character to move forward, backward, turn left, turn right, or the like, or may change the scene and present the virtual environment when the touch panel 41 is applied to the VR/AR joystick. When the charging case works in the mouse mode or the charging case mode, the function of the touch panel 41 may be turned off to prevent false triggering. The touch panel 41 may be composed of a touch integrated chip, or may be implemented by a capacitive touch array.

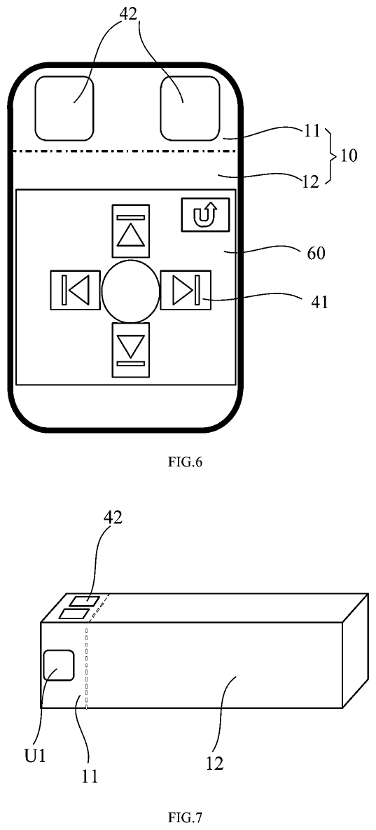

Referring to FIGS. 7-9, in an embodiment, the sensor module 30 comprises:

a plurality of ultrasonic sensors U1 respectively provided on adjacent sidewalls at an end of the case body 10, and connected to the main controller 50 respectively:

a motion sensor U2 provided in the case body 10 and connected to the main controller 50:

the main controller 50 is further configured for when the multifunctional earphone charging case works in the joystick mode, controlling the plurality of ultrasonic sensors U1 to work such that the plurality of ultrasonic sensors U1 transmit ultrasonic signals to the terminal device; and/or, controlling the motion sensor U2 to work so as to acquire a rotation direction and acceleration information of the multifunctional earphone charging case.

In the present embodiment, the ultrasonic sensors U1 are ultrasonic transmitting sensors, and the number thereof may be three, which may be located on a case cover of the charging case. The three sensors are respectively provided on three sidewalls at an end of the case body 10, may form a triangulation configuration, and may transmit ultrasonic signals to the terminal device, such as AR glasses or other AR devices which are provided with a corresponding number of ultrasonic wave receiving sensors. When the user makes a corresponding action through the charging case, the charging case will change the angle with the user's action, the ultrasonic receiving sensors on the terminal device may track the position of the charging case in the space according to the angle change of the charging case, thereby capturing the user's action and cooperating with the AR device or the ultrasonic devices on the VR device to complete the spatial positioning. In the present disclosure, since the ultrasonic sensors U1 may directly perform signal transmission with the ultrasonic devices on the terminal device without indirect signal processing and transmission through the main controller 50, Bluetooth and other modules, the present disclosure may improve the signal interaction speed between the charging case and the terminal device, is conducive to improving the signal response speed of the terminal device, and may shorten the delay of the response speed between the user's action and the terminal device.

In the present embodiment, the motion sensor U2 may adopt a six-axis inertial sensor, an acceleration sensor, a gyroscope, etc., to complete the detection of the rotation direction and acceleration information of the charging case itself and output the information to the main controller 50. The main controller 50 may perform data processing on the information, such as decoding, encoding, analog-to-digital conversion, etc., and control the wireless communication module to send the information to the terminal device, thereby implementing the VR/AR joystick function.

Referring to FIG. 6, in an embodiment, the sensor module 30 further comprises:

a display module 60 provided on the case body 10 and connected to the main controller 50:

the main controller 50 is further configured for when the multifunctional earphone charging case works in the joystick mode, controlling the display module 60 to operate, and outputting a display control signal to the display module 60 for displaying image information.

In the present embodiment, the display module 60 may be used to display the information to be touched, the current status of the charging case, the connection status between the charging case and the terminal device, and so on. The display module 60 may be installed on the case body 10, may be specifically installed at a place where the user needs to work, and of course, may also be adjusted adaptively according to the size, shape, etc., which is not limited herein. The display module 60 may be implemented by using an LED display screen, an LCD display screen, or the like.

Of course, in other embodiments, the main controller 50 may also control the display module 60 to work according to the current working mode of the charging case, so as to display the current working mode of the charging case on the display screen. For example, when the charging case works in the joystick mode, the main controller 50 may control the display module 60 to display words such as “joystick”, and when the charging case works in the mouse mode, the main controller 50 may control the display module 60 to display words such as “mouse”. In some embodiments, when applied to the charging case mode, the display module 60 may further be used for displaying the power of the charging case, the charging power of the wireless earphone, and so on. The brightness and display time of the display module 60 may be adjusted according to difference of the modes. For example, in the joystick mode, the display module 60 may be in always-on mode, while in the mouse mode and the charging case mode, the display module 60 can be lit based on the user's trigger, and otherwise it does not work. In this way, by utilizing the display to show the identification of the device to be controlled for human-computer interaction, the user may be informed of the current operating mode of the charging case while realizing the joystick function. The display module 60 of the present disclosure may adapt to the requirements of the charging case in different modes, thereby realizing functionality while also reducing power consumption.

In the above embodiments, the display module 60 may be implemented by using a touch display module 60, and the touch display module 60 comprises a display screen and a touch panel 60 disposed on the display screen. Depending on the product to be used, it is determined whether the display function needs to be triggered. For example, when used in conjunction with VR glasses, in the process of using VR glasses in conjunction with the charging case, due to the immersive nature of the VR glasses, it is not possible to see the information on the display on the charging case directly through the eyes, so it is possible to replace the display touch module with a capacitive touch panel, which helps to reduce costs. The display screen may be eliminated and only the touch panel 41 is needed to realize the joystick function. In a scenario where the AR is used in conjunction with the charging case, since AR glasses are optical perspective, display and touch modules may be configured on the charging case, which makes information display more intuitive and control more convenient. When there are multiple VR/AR devices, they may be selected via the Bluetooth device to be paired on the display screen of the charging case. In a specific embodiment, the button detection circuit 42, the display module 60 and the touch panel 41 may be configured on the back of the charging case body 10, which also allows for joystick and remote-control functions without affecting the overall appearance of the charging case, thus greatly facilitating mouse, AR and VR operations.

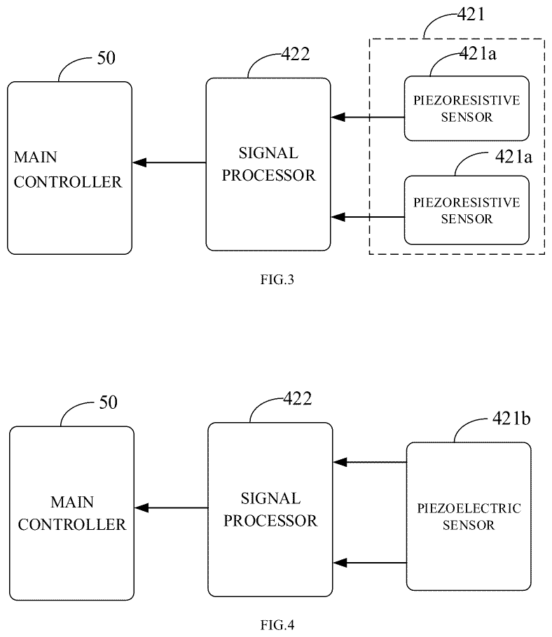

Referring to FIGS. 3-4, in an embodiment, the user inputting module 40 further comprises:

a button detection circuit 42 comprising pressure detecting components 421 and a signal processor 422 whose output end is connected to the main controller 50, the pressure detecting components 421 being provided on an inner wall of the case body 10 and respectively connected to a signal detecting end of the signal processor 422:

the main controller 50 is further configured for when the multifunctional earphone charging case works in the mouse mode, controlling the button detection circuit 42 to work, and receiving pressure values acquired by two pressure detecting components 421 so as to determine an area where the multifunctional earphone charging case is clicked.

Wherein, the pressure detecting component 421 is a piezoresistive sensor 421a and/or a piezoelectric sensor 421b.

In the present embodiment, the pressure detecting component 421 may adopt a resistive, capacitive, or piezoelectric sensor, and in the case of a piezoresistive sensor, the processor may be consisted of a multi-channel AFE IC (implemented by an analog front-end chip) for implementing the detection and processing of the pressing force. When the pressure detecting component 421 is implemented by the piezoelectric sensor 421b (such as a piezoelectric ceramic chip), it may be implemented by a piezoelectric special detection chip matched with the piezoelectric sensor. The number of the pressure detecting components 421 may be set differently depending on the type of the pressure detecting components 421. For example, when the piezoresistive sensor is adopted, the number of the pressure detecting components 421 is two, and corresponding to positions of the two pressure detecting components 421, the case body 10 is provided with two press areas. When the user performs a pressing operation in the corresponding press areas, the pressure generated by the pressing operation is transmitted via the housing to the pressure detecting components 421 corresponding to the press areas, which causes the pressure detecting components 421 to generate pressure information, and based on the relationship between the pressure information and the set pressure threshold, it is possible to determine the press area to be pressed. For example, the pressure acquired by the pressure detecting component 421 corresponding to the two areas is compared with the set pressure threshold, and when the pressure acquired by one pressure detecting component 421 in the two areas is greater than or equal to the set pressure threshold, it is considered that the user has performed a pressing operation in the press area, such as clicking a left button. When the pressure acquired by the pressure detecting component 421 in the other area is less than the set pressure threshold, it is considered that the user has performed a pressing operation in the second press area, such as clicking a right button.

It can be understood that the pressure detecting components 421 in the present embodiment may be provided on the inner wall of the housing without the need to provide a piezoelectric touch button or piezoresistive touch button on the housing to implement the left and right buttons on the earphone charging case (left and right buttons on a universal mouse), which eliminates the need to make a hole in the housing of the complete machine, ensures consistency in the appearance of the overall ID, and avoids disruption of the overall ID by common physical buttons. The exterior surface of the charging case is seamless and thus is waterproof and dustproof.

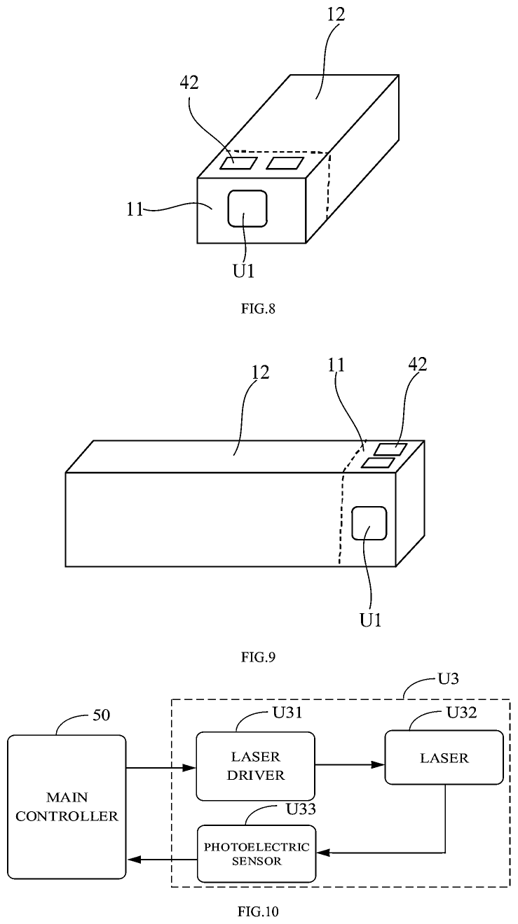

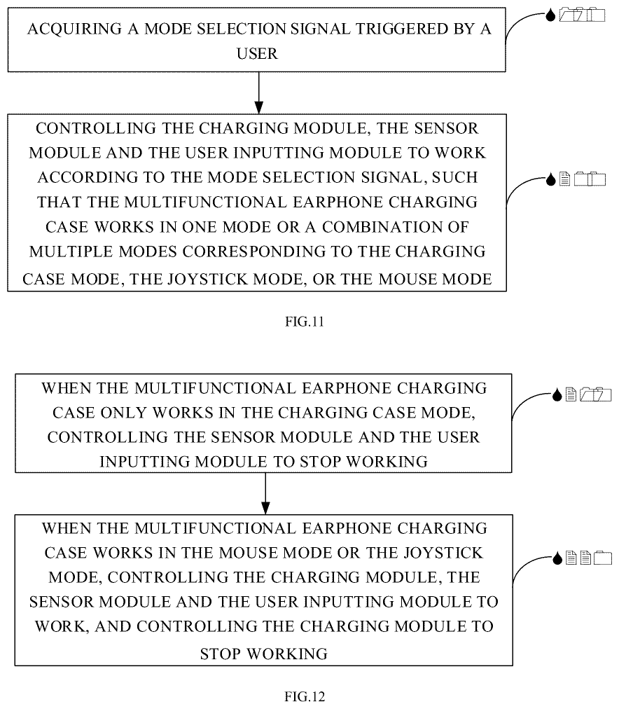

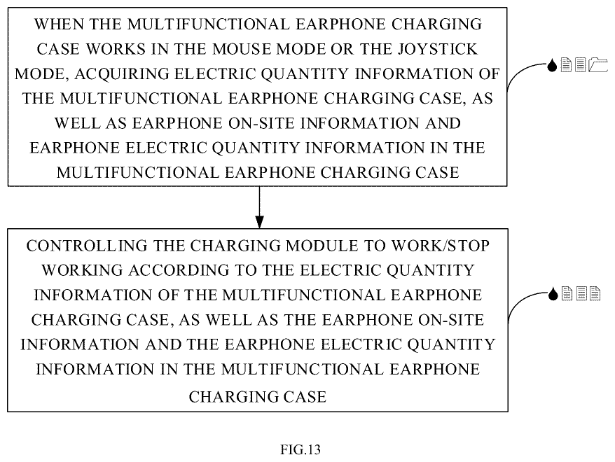

Referring to FIG. 10, in an embodiment, the sensor module 30 further comprises:

a displacement detection sensor U3 provided on the case body 10 and connected to the main controller 50:

the main controller 50 is further configured for when the multifunctional earphone charging case works in the mouse mode, controlling the displacement detection sensor U3 to work, and receiving a displacement detection value acquired by the displacement detection sensor U3 so as to determine a current position of the multifunctional earphone charging case.

In the present embodiment, the displacement detection sensor U3 may be composed of a laser driver U31, a laser driver U32 and a photoelectric sensor U33 for completing the detection of the moving distance, and will generate a displacement when moving the charging case on a flat surface such as a tabletop by driving the laser U32 through the laser driver U31 to emit a laser signal. The sensor U33 may sense the change of displacement and output it to the main controller 50 so as to determine the current position of the multifunctional earphone charging case, such that the charging case may realize the mouse function.

The present disclosure further provides a terminal control system, comprising a terminal device and the above multifunctional earphone charging case:

the terminal device is in wireless communication connection with the multifunctional earphone charging case.

The detailed structure of the multifunctional earphone charging case may refer to the above embodiments, which will not be repeated herein: it can be understood that since the multifunctional earphone charging case described above is used in the terminal control system of the present disclosure, the embodiments of the terminal control system of the present disclosure include all the technical solutions of all the embodiments of the above multifunctional earphone charging case, and may achieve the same technical effects as the embodiments, which will not be repeated herein. In the present embodiment, the terminal device may be a mobile phone, a television, a VR device, or an AR device, and may achieve the corresponding function when the charging case is in wireless communication connection with these terminal devices.

The present disclosure further provides a control method for a multifunctional earphone charging case, and the multifunctional earphone charging case is provided with a charging module, a sensor module and a user inputting module.

Referring to FIG. 11, the control method for a multifunctional earphone charging case comprises following steps:

Step S100, acquiring a mode selection signal triggered by a user:

In the present embodiment, the mode selection signal triggered by the user may be a button control signal (e.g., a button provided on the charging case, a number of times the button is pressed, a length of time the button is pressed, etc.), an action signal triggered by the user (e.g., shaking, flinging the charging case, etc.), or a gesture signal generated by controlling an attitude of the charging case (e.g., horizontal, vertical, front face up, back face up, etc.), etc., and the present embodiment may select a button control signal generated by trigger the button.

Step S200, controlling the charging module, the sensor module and the user inputting module to work according to the mode selection signal, such that the multifunctional earphone charging case works in any one or any combination of the charging case mode, the joystick mode, and/or the mouse mode.

In the present embodiment, in response to the mode selection signal triggered by the user, controlling the working state of the charging module, the sensor module and the user inputting module. Specifically, when the user triggers a mode selection signal that characterizes only the charging case to charge the wireless earphone, controlling the charging module to supply power to the wireless earphone to charge the wireless earphone, and at this time, the sensor module and the user inputting module are in a non-working state. When the user triggers a mode selection signal characterizing that the charging case works only in the mouse mode, controlling the charging module to stop supplying power so as to stop charging the wireless earphone, and at this time, in the sensor module and the user inputting module, sensors, buttons and the like for realizing the mouse function are in the working state, and other sensors and the touch panel unrelated to the mouse function may be in the non-working state. Similarly, when the user triggers a mode selection signal characterizing that the charging case only works in the joystick mode, controlling the charging module to stop supplying power so as to stop charging the wireless earphone, and at this time, in the sensor module and the user inputting module, sensors, buttons and the like for realizing the joystick function are in the working state, and other sensors unrelated to the joystick function may be in the non-working state. When the user triggers a mode characterizing that the two modes are compatible at the same time, in the charging module, the sensor module, and the user inputting module, the corresponding modules are in the working state, and other functions unrelated to the two modes may stop working, thereby reducing the power consumption generated by the sensor module and the user inputting module during standby. When controlling the working states of the modules such as the charging module, the sensor module, and the user inputting module, the control may be realized by controlling the on/off between the modules and the power supply, or in the module with the enabling function, the working state of the module may be changed by enabling the module, which may specifically be realized according to the adopted device and the like, and is not limited herein. The present disclosure provide a new charging case, which integrates the functions of the TWS earphone charging case, the AR/VR joystick and the mouse into the multi-functional earphone case in terms of overall function, thus realizes functions of the mouse, the AR matching joystick, and the earphone charging storage box on the same charging case, realizes the integration and expansion of the functions of the charging case, contributes to simplifying the kinds of peripherals and may improve the convenience of being carried by the user. The charging case of the present disclosure is suitable for the needs of the user in different application scenarios, and improves the convenience of the operation on the terminal device by the user.

Referring to FIG. 12, in an embodiment, a step of said “controlling the charging module, the sensor module and the user inputting module to work according to the mode selection signal, such that the multifunctional earphone charging case works in any one or any combination of the charging case mode, the joystick mode, and/or the mouse mode” specifically comprises:

Step S210, when the multifunctional earphone charging case only works in the charging case mode, controlling the sensor module and the user inputting module to stop working:

Step S220, when the multifunctional earphone charging case works in the mouse mode or the joystick mode, controlling the charging module, the sensor module and the user inputting module to work, or controlling the charging module to stop working.

In the example, in order to ensure that functions of joystick mode and mouse mode can be better realized, and reduce the running burden of the processor in the charging case, the present embodiment may control the charging case to stop charging when the charging case works in the joystick mode and the mouse mode, and when the charging case is switched to the charging case mode, may control the wireless earphone to continue charging or stop charging according to the power of the wireless earphone battery.

Referring to FIG. 12, in an embodiment, a step of said “controlling the charging module, the sensor module and the user inputting module to work according to the mode selection signal, such that the multifunctional earphone charging case works in any one or any combination of the charging case mode, the joystick mode, and/or the mouse mode” specifically comprises:

Step S231, when the multifunctional earphone charging case works in the mouse mode or the joystick mode, acquiring electric quantity information of the multifunctional earphone charging case, as well as earphone on-site information and earphone electric quantity information in the multifunctional earphone charging case:

Step S232, controlling the charging module to work/stop working according to the electric quantity information of the multifunctional earphone charging case, as well as the earphone on-site information and the earphone electric quantity information in the multifunctional earphone charging case.

In the present embodiment, the charging case may work in only one mode or work in two modes at the same time, and even the three modes of the charging case mode, the joystick mode and the mouse mode may be compatible at the same time. When working in two modes at the same time, the two modes may be charging case mode and the joystick mode, or the charging case mode and the mouse mode, or the joystick mode and the mouse mode, which may specifically be selected and controlled according to the user's needs, whether the charging case supports the power, whether the wireless earphone is placed in the charging case, and whether the wireless earphone needs to be charged when it is placed in the charging case, which is not limited herein.

When the charging case mode is simultaneously compatible with one or two of the other two modes, after entering into the joystick mode and/or the mouse mode, whether the charging case mode needs to be started may also be determined according to the electric quantity information of the charging case, whether the earphone is in the case body, and whether the earphone needs to be charged. Specifically, the charging case mode may be maintained when the electric quantity of the battery of the charging case is sufficient to maintain the two modes or the three modes to be carried out simultaneously, and when the current of the battery of the charging case is not sufficient to support the two modes to be carried out simultaneously, the charging case may be controlled to stop charging the wireless earphone. Alternatively, when the wireless earphone is not in the case body, the charging case can also be controlled to stop supplying power to the charging port connected to the wireless earphone. Alternatively, when the power of the wireless earphone is sufficient, supplying power to the charging port connected to the wireless earphone may also be stopped.

The above description is only optional embodiment of the present disclosure, and is not intended to limit the patent scope of the present disclosure. Any equivalent structural transformation made under the inventive concept of the present disclosure by utilizing the contents of the specification and the accompanying drawings of the present disclosure, or direct/indirect application thereof in other related technical fields, shall be included in the patent protection scope of the present disclosure.

1. A multifunctional earphone charging case configured with a charging case mode, a joystick mode, and a mouse mode, comprising:
a case body;
a charging module provided in the case body;
a sensor module provided on the case body;
a user inputting module provided on the case body; and
a main controller electrically connected to the charging module, the sensor module, and the user inputting module respectively, the main controller being configured for controlling the charging module, the sensor module, and the user inputting module operable according to a mode selection signal triggered by a user, such that the multifunctional earphone charging case is configured for one or more of the charging case mode, the joystick mode, or the mouse mode.

2. The multifunctional earphone charging case according to claim 1, wherein the mode selection circuit comprises:
a function selection button provided on the case body, connected to the main controller, and outputting corresponding a mode selection signal when triggered by the user.

3. The multifunctional earphone charging case according to claim 1, wherein the multifunctional earphone charging case further comprises a wireless communication module configured for a wireless communication connection between the main controller and a terminal device;
the mode selection circuit further comprises:
a pairing button provided on the case body, connected to the main controller, and outputting a pairing button signal when triggered by the user;
the main controller is further configured for controlling the wireless communication module and the terminal device to establish the wireless communication connection when receiving the pairing button signal.

4. The multifunctional earphone charging case according to claim 1, wherein the user inputting module comprises:
a touch panel provided on a housing and connected to the main controller;
the main controller is further configured for, when the multifunctional earphone charging case is in the joystick mode, controlling the touch panel to work, receiving a touch information generated when the touch panel is triggered by the user, and generating a corresponding control signal according to the touch information.

5. The multifunctional earphone charging case according to claim 1, wherein the sensor module further comprises:
a display module provided on the case body and connected to the main controller;
the main controller is further configured for, when the multifunctional earphone charging case is in the joystick mode, controlling the display module to work, and outputting a display control signal to the display module for displaying image information.

6. The multifunctional earphone charging case according to claim 1, wherein the sensor module comprises:
a plurality of ultrasonic sensors respectively provided on adjacent sidewalls at an end of the case body, and connected to the main controller respectively;
a motion sensor provided in the case body and connected to the main controller;
the main controller is further configured for, when the multifunctional earphone charging case is in the joystick mode, controlling the plurality of ultrasonic sensors to work such that the plurality of ultrasonic sensors transmit ultrasonic signals to the terminal device; and/or, controlling the motion sensor to work so as to acquire a rotation direction and acceleration information of the multifunctional earphone charging case.

7. The multifunctional earphone charging case according to claim 1, wherein the user inputting module further comprises:
a button detection circuit comprising pressure detecting components and a signal processor, wherein the signal processor has an output end is connected to the main controller, and the pressure detecting components is provided on an inner wall of the case body and respectively connected to a signal detecting end of the signal processor;
the main controller is further configured for, when the multifunctional earphone charging case is in the mouse mode, controlling the button detection circuit to work, and receiving pressure values acquired by two pressure detecting components so as to determine an area where the multifunctional earphone charging case is clicked.

8. The multifunctional earphone charging case according to claim 1, wherein the sensor module further comprises:
a displacement detection sensor provided on the case body and connected to the main controller;
the main controller is further configured for, when the multifunctional earphone charging case is in the mouse mode, controlling the displacement detection sensor to work, and receiving a displacement detection value acquired by the displacement detection sensor so as to determine a current position of the multifunctional earphone charging case.

9. A terminal control system, comprising a terminal device and a multifunctional earphone charging case according to claim 1;
Wherein the terminal device is in a wireless communication connection with the multifunctional earphone charging case.

10. A control method for a multifunctional earphone charging case provided with a charging module, a sensor module, and a user inputting module, comprising:
acquiring a mode selection signal triggered by a user;
controlling the charging module, the sensor module, and the user inputting module to work according to the mode selection signal, such that the multifunctional earphone charging case is configured for one or more of the charging case mode, the joystick mode, or the mouse mode.

11. The control method for a multifunctional earphone charging case according to claim 10, wherein said controlling the charging module, the sensor module, and the user inputting module to work according to the mode selection signal, such that the multifunctional earphone charging case is configured for one or more of the charging case mode, the joystick mode, or the mouse mode, comprises:
when the multifunctional earphone charging case is only in the charging case mode, controlling the sensor module and the user inputting module to stop working;
when the multifunctional earphone charging case is in the mouse mode or the joystick mode, controlling the charging module, the sensor module, and the user inputting module to work, or controlling the charging module to stop working.

12. The control method for a multifunctional earphone charging case according to claim 10, wherein said controlling the charging module, the sensor module, and the user inputting module to work according to the mode selection signal, such that the multifunctional earphone charging case is configured for one or more of the charging case mode, the joystick mode, or the mouse mode, comprises:
when the multifunctional earphone charging case is in the mouse mode or the joystick mode, acquiring electric quantity information of the multifunctional earphone charging case, earphone on-site information, and earphone electric quantity information in the multifunctional earphone charging case;
controlling the charging module to work/stop working according to the electric quantity information of the multifunctional earphone charging case, the earphone on-site information, and the earphone electric quantity information in the multifunctional earphone charging case.
